(19) United States
(12) Patent Application Publication
(10) Pub. No.: US 2011/0043726 A1
(43) Pub. Date: Feb. 24, 2011

(54) Display with split electrode between two substrates

(75) Inventors: Mahyar Vahabzadeh, Phoenix, AZ (US); William F. Scholz, Scottsdale, AZ (US); Karen Ruth Brower, Chandler, AZ (US)

Correspondence Address: Paul F. Wille;Cantor Colburn LLP, 22nd Floor, 20 Church St., Hartford, CT, 06103-3207, US

(73) Assignee: World Properties, Inc., Lincolnwood, IL (US)

(21) Appl. No.: 12/583,262

(22) Filed: Aug. 18, 2009

(51) Int. Cl. G02F 1/13357; G02F 1/13

(52) U.S. Cl. 349/69; 349/187

(57) ABSTRACT

A light shutter and an EL panel are sandwiched between two substrates, one of which includes a common front electrode. The common front electrode is electrically floating. Patterned rear electrodes, on either side of the EL panel, are capacitively coupled to each other by the common front electrode. The rear electrodes can be segmented and the segments addressed individually. Each substrate is coated with a layer of PDLC and the substrates are laminated by joining the layers of PDLC.

### CROSS-REFERENCE TO RELATED APPLICATION

This application relates to application Ser. No. 12/229,050, filed Aug. 19, 2008, entitled Liquid Crystal Display with Split Electrode, assigned to the assignee of this invention, and incorporated herein by reference.

### BACKGROUND TO THE INVENTION

This invention relates to a light shutter and a thick film EL back light between two substrates.

### GLOSSARY

As used herein, a “display” is a device that provides information in visual form to a viewer.

A “graphic” can be text, a symbol, an arbitrary shape, or some combination thereof. A graphic can be translucent, diffuse, shaded, colored, a silhouette or outline, or some combination thereof. Graphics can be positive (black on white) or negative (white on black), where white is diffuse, shaded, etc.

An “EL layer” is a layer containing phosphor and dielectric or separate layers of phosphor and dielectric.

A “phosphor” is not restricted to a single type of phosphor or dopant and does not exclude cascading phosphors or dyes for color enhancement.

An “EL lamp” is a thick film, capacitive device including an EL layer between two electrodes, at least one of which is transparent. The phosphor is luminous when a voltage is applied to the electrodes. A “panel” is a plurality of EL lamps on a common substrate. The lamps may be operated independently of one another or in unison. Alternating current must be used to drive an EL lamp.

A “floating” electrode has no direct or ohmic or resistive contact to a source of voltage or current.

A “thick film” EL lamp refers to one type of EL lamp and “thin film” EL lamp refers to a different type of EL lamp. The terms only broadly relate to actual thickness and actually identify distinct disciplines. A thin, thick film EL lamp is not a contradiction in terms and such a lamp is much thicker than a thin film EL lamp.

“Opaque” does not mean that no light is transmitted, only that the amount of light transmitted is substantially reduced, e.g. to fifteen percent of incident light.

“Overlying” or “underlying” do not imply orientation and merely describe a situation wherein layers of materials have major surfaces facing each other, with or without contact. The surfaces are not necessarily planar.

In general, all words are used without resort to extreme interpretation or to semantics at the expense of reality. The words are used within their ordinary meaning, either in everyday speech or as jargon in a particular technology, as appropriate.

A liquid crystal display is a capacitive structure, having a dielectric (liquid crystal) between two electrodes, at least one of which is transparent. Often both electrodes are transparent and typically are made from indium tin oxide (ITO) sputtered on a transparent substrate, such as a dimensionally stable, transparent sheet of plastic. In order to provide graphic or alpha-numeric information, at least one of the electrodes is patterned. Typically, this includes screen printing a mask and etching the ITO layer. Etching is a chemical process with attendant problems, and cost, of handling and waste treatment.

In the last twenty years, a particular class of materials, known as polymer dispersed liquid crystals (PDLC), has been developed for displays; e.g., see U.S. Pat. No. 4,992,201 (Pearlman). Devices using these materials operate on alternating current at 60-120 volts peak-to-peak, unlike earlier liquid crystal materials that operated at much lower voltages, and provide contrast without the need for polarizers. Sometimes referred to as “optical shutters,” polymer dispersed liquid crystals have uses outside the realm of displays.

U.S. Pat. No. 6,842,170 (Akins et al.) discloses a liquid crystal display combined with an electroluminescent (EL) back light and a touch screen. The liquid crystal display is part of a keypad, containing a mask layer with images of the buttons on a telephone (0-9, * and #) and other control buttons. It is also disclosed that the liquid crystal display and the EL back light can share a common substrate.

International Publication WO 2005/121878 discloses a liquid crystal display and an EL back light on the same side of a substrate, as does U.S. Application Publication 2002/0163606 (Kitai et al.). Other permutations are known in the art, with devices on opposite sides of a substrate; e.g., see U.S. Pat. No. 5,121,234 (Kucera) and U.S. Pat. No. 6,441,551 (Abe et al.). Various interlayers or outer layers for affecting optical performance, e.g. color, reflectance, and dispersion, are also known in the art. These devices are typically built front to rear, which means that the first layer on the substrate is a transparent front electrode. Subsequent layers cover the front electrode, making electrical contact with the front electrode difficult. Also, bus bars must be used to reduce resistance from the electrode to a point of contact, which can introduce additional problems with location and uneven thickness, particularly for multi-segment displays.

An EL device emits light at almost any applied voltage. Useful amounts of light generally require more than sixty volts rms. Liquid crystal devices are more like switches: they do not change state until a threshold voltage is reached, e.g. eighty volts rms. For PDLC, the voltage is 10-40 volts rms. The response curve is not perfectly square—that would be impossible because of the voltage gradient across the thickness of the material—but the change is relatively abrupt, certainly compared with the roughly linear response of an EL lamp to voltage; e.g. see U.S. Application Publication 2006/0250534 (Kutscher et al.).

Driving EL and PDLC between a single pair of electrodes, as disclosed in the '234 patent and the '551 patent, is not entirely straightforward. For some applications, the answer is simple. Apply a large enough voltage to open shutters and cause the EL lamps to emit light. For multi-segment displays, there was no simple answer to driving EL and PDLC simultaneously, e.g. because of problems routing conductive traces.

The choice of a technology for a particular display is a balance of competing interests, not the least of which is cost. In the case of cellular telephones, the choice is often based on the presumption that the user will be indoors or at least not in direct sunlight when the telephone is used. In other words, the content of the display all but vanishes in bright light because the display relies on luminous back lighting for visibility. Many liquid crystal displays rely on reflective back lighting. Thus, the back lighting increases or decreases with ambient light and the content of the display remains visible. Some displays try for the best of both worlds with a “transflective” layer between a back light and a liquid crystal module.

Screen printing and roll coating are both well known processes for manufacturing EL lamps and other devices. A problem with screen printing is the cost and handling of product in a piecemeal fashion. A problem with roll coating liquid crystal material is the need to provide access to the first deposited electrode for electrical contact. Etching is costly, both in the number of steps and in the possibly environmentally unfriendly materials used for etching. Other solutions, e.g. such as disclosed in U.S. Pat. No. 5,821,691 (Richie et al.) are useful but restrict the location of the first electrode.

It is known in the art of electroluminescent lamps to capacitively couple to the first deposited electrode by using a split electrode on the opposite side of a panel; e.g. see U.S. Pat. No. 2,928,974 (Mash). It is also known that there is a problem with this approach because brightness is proportional to area; e.g. see U.S. Pat. No. 5,508,585 (Butt). This means that two or more electrodes must be equal in area in order for the lamps to be equal in luminance, all other factors being the same.

U.S. Pat. No. 6,934,313 (Deacon) discloses an optical waveguide of PDLC material having two electrodes on one side of the PDLC material and a third electrode on the other side of the PDLC material. The two electrodes are not capacitively coupled to each other by the third electrode because the third electrode does not float electrically. Transparent electrodes are also disclosed.

It is known in the art to construct a thick film EL lamp either “light side up” or “dark side up”; U.S. Pat. No. 4,513,023 (Wary). It is known in the art to laminate EL lamp materials to a liquid crystal display; U.S. Pat. No. 6,433,476 (Paciorek et al.).

In application Ser. No. 12/229,050, a PDLC coated substrate is the substrate upon which an EL lamp is constructed. This requires that subsequent printing and drying steps not affect the PDLC layer, a condition that is not always obtained. The PDLC layer may change optical or electrical characteristics. For example, a change in optical characteristics is increased opacity. A change in electrical characteristics is an increase in switching voltage, which is undesirable.

In view of the foregoing, it is therefore an object of the invention to provide a display in which the EL lamp is compatible with PDLC layers from various sources.

Another object of the invention is to provide a display having split electrode capacitively coupled to a floating electrode.

A further object of the invention is to provide a method for making a back lit PDLC display without affecting the PDLC layer during manufacture.

Another object of the invention is to provide a common, floating, front electrode for stacked PDLC and EL layers.

A further object of the invention is to provide capacitively coupled electrodes for PDLC and EL layers.

Another object of the invention is to provide optimum drive voltages for each layer in a stack including a PDLC layer and a EL layer.

A further object of the invention is to provide a light shutter and a EL panel between two substrates with a common front electrode and separate rear electrodes.

Another object of the invention is to provide a convenient method for making a display containing an EL layer and PDLC.

### SUMMARY OF THE INVENTION

The foregoing objects are achieved by this invention in which a light shutter and an EL panel are sandwiched between two substrates, one of which includes a common front electrode. The common front electrode is electrically floating. Patterned rear electrodes, on either side of the EL panel, are capacitively coupled to each other by the common front electrode. The rear electrodes can be segmented and the segments addressed individually. Each substrate is coated with a layer of PDLC and the substrates are laminated by joining the layers of cured or dried PDLC.

### BRIEF DESCRIPTION OF THE DRAWINGS

A more complete understanding of the invention can be obtained by considering the following detailed description in conjunction with the accompanying drawings, in which:

FIG. 1 illustrates the assembly of a light shutter and an EL lamp in accordance with a preferred embodiment of the invention;

FIG. 2 illustrates a preferred method for assembling a display constructed in accordance with the invention; and

FIG. 2 is a cross-section of a completed assembly.

### DETAILED DESCRIPTION OF THE INVENTION

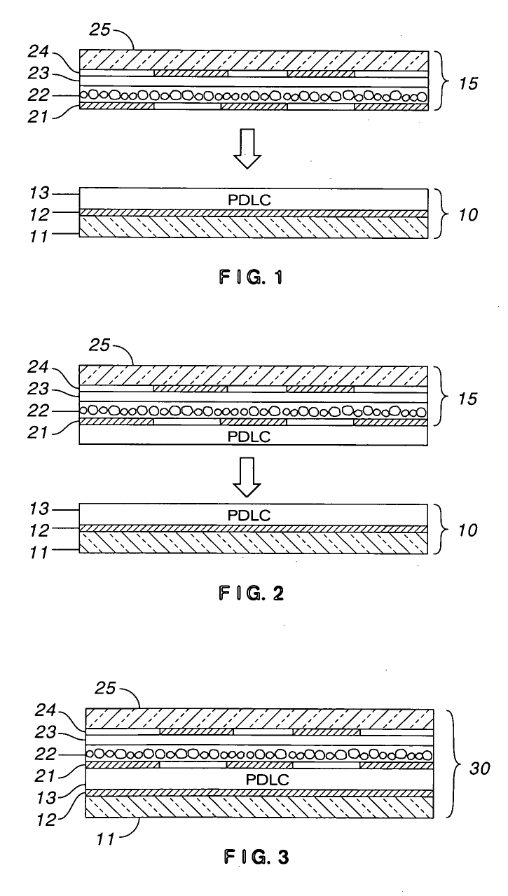

FIG. 1 illustrates light shutter 10 receiving EL lamp 15. Each device is made on its own substrate and the devices are joined with the substrates on the outside of the combination. Light shutter 10 includes transparent substrate 11 and transparent electrode 12 overlying one major surface of the substrate. Liquid crystal layer 13 overlies electrode 12. Substrate 11 can be glass or any transparent polymeric material, such as polycarbonate or polyethylene terephthalate (PET). It is only required that the substrate be transparent and can be coated with an adherent layer of transparent, conductive material. The thickness of substrate 11 is not critical and depends upon application. A PET substrate having a thickness of 1-7.5 mils (0.025-0.188 mm) is preferred. Transparent electrode 12 is preferably indium tin oxide. Liquid crystal layer 13 is preferably a polymer dispersed liquid crystal that has been roll coated onto electrode 12.

EL lamp 15 is shown in simplified cross-section, without isolation layers, bus bars and the like, as shown in application Ser. No. 12/229,050. EL lamp 15 includes a first rear electrode 21, phosphor layer 22, dielectric layer 23, second rear electrode 24 and substrate 25. Substrate 25 is preferably the same material as substrate 11, although this is not required. The layers are applied to substrate 25 in the reverse order as their listing. In other words, EL lamp 15 is manufactured “lit side up.” In function, electrode 21 is a transparent front electrode for EL lamp 15. Electrodes 21 and 24 are patterned to produce the desired displays by light shutter 10 and EL lamp 15.

Light shutter 10 and EL lamp 15 are assembled by laminating EL lamp 15 to light shutter 10. If PDLC layer 13 has just been roll coated, the surface is tacky and the EL lamp adheres. If the surface is not tacky, it can be made so by warming or by coating with a tacking agent, solvent, or an adhesive. EL lamp 15 is slightly curved to prevent trapping air during lamination.

In accordance with another aspect of the invention, illustrated in FIG. 2, transparent electrode 12 and EL lamp 15 are each coated with a layer of PDLC. The layers of PDLC are dried without contact. Then the PDLC layers are laminated under heat and pressure. This is a preferred method for assembling a display in accordance with the invention. By way of example only, in one embodiment of the invention, the layers were laminated at 300° F. (as indicated on the laminating equipment) at 50 PLI (pounds per linear inch) with the material moving at one foot per minute. Other values can be used instead and are easily determined empirically for a given batch of PDLC.

Assembled display 30 is illustrated in simplified cross-section in FIG. 3. In operation, first rear electrode 21 and second rear electrode 24 are coupled to each other by floating front electrode 12. The three electrodes act as the plates of series connected capacitors, dividing an applied voltage between the first rear electrode and the floating electrode (a first capacitor) and the second rear electrode and the floating electrode (a second capacitor). Light is emitted through transparent substrate 11.

The invention thus provides a display having a light shutter and EL lamp between two substrates. The display includes a floating electrode and a split electrode that is capacitively coupled to the floating electrode. Because an electrode is floating, a PDLC layer can be roll coated over the floating electrode, reducing costs, providing greater uniformity, and simplifying construction. Because the EL lamp is assembled separately from the PDLC material, manufacture of the EL lamp does not degrade the PDLC. The split electrodes can independently control the shutter and the EL lamp. By controlling capacitance, one can optimize drive voltages for the PDLC layer and the EL layers.

Having thus described the invention, it will be apparent to those of skill in the art that various modifications can be made within the scope of the invention. For example, although described in terms of the electrodes defining a pattern, the phosphor layer can be patterned (e.g. screen printed) instead of or in addition to having patterned electrodes. Gaps in the pattern can be used as “dummy” loads for adjusting capacitance and voltage.

What is claimed as the invention is:

1. A display comprising:
a first substrate;
a second substrate;
a liquid crystal layer and an EL layer between said first substrate and said second substrate.

2. The display as set forth in claim 1 wherein said liquid crystal layer includes polymer dispersed liquid crystal material.

3. The display as set forth in claim 1 wherein the first substrate is transparent, a transparent electrode overlies the first substrate, and the liquid crystal layer overlies the transparent electrode.

4. The display as set forth in claim 3 wherein a first rear electrode overlies the liquid crystal layer, the EL layer overlies the first rear electrode, and a second rear electrode overlies the EL layer, wherein the first rear electrode is transparent.

5. The display as set forth in claim 4 wherein said first rear electrode and said second rear electrode are patterned.

6. The display as set forth in claim 5 wherein said patterning defines plural segments that can be addressed individually in at least one of said first rear electrode and said second rear electrode.

7. The display as set forth in claim 4 wherein said transparent electrode is electrically floating and capacitively coupled to said first rear electrode and said second rear electrode.

8. The display as set forth in claim 1 wherein the EL layer includes a patterned layer of phosphor.

9. A method for making the display set forth in claim 1, said method comprising the steps of:
applying said EL layer to said first substrate;
applying a first liquid crystal layer over said EL layer;
applying a second liquid crystal layer to said second substrate; and
joining said liquid crystal layers under heat and pressure to laminate the substrates.

10. The method as set forth in claim 9 wherein said first liquid crystal layer and said second liquid crystal layer are dried prior to joining.
